(19) United States
(12) Patent Application Publication
(10) Pub. No.: US 2024/0325934 A1
(43) Pub. Date: Oct. 3, 2024

(54) SYSTEM, COMPUTING DEVICE, AND METHOD IMPLEMENTING AN ONLINE DISTRIBUTED ANAGRAM GAME

(71) Applicant: Forbes Media LLC, New York, NY (US)

(72) Inventors: Reilly Tuccinard, Washington, DC (US); Benjamin Wexler, New York, NY (US); Andres Jauregui, Bath, ME (US); Pranav Shinde, Rochester, NY (US)

(21) Appl. No.: 18/194,230

(22) Filed: Mar. 31, 2023

(51) Int. Cl. A63F 13/822; A63F 13/2145; A63F 13/537

(52) U.S. Cl. CPC A63F 13/822; A63F 13/2145; A63F 13/537

(57) ABSTRACT

A computer-based system implements an online distributed anagram game. The system includes a computing device and a computer-based server. A memory of the computing device stores a plurality of game states including an initial, intermediate, and final game states. A display has blank screen regions, and additional screen regions with alphabetical symbols scrambled as a current anagram. A memory of the server stores a solution to the current anagram unscrambled as the final game state. Inputs from the user are interactively processed to modify the blank screen regions from the initial game state to intermediate game states. Upon an intermediate game state matching the final game state, the user receives a final score. Using a clock, a timer starts upon initiation of the anagram game, and the timer stops upon the matching of game states. A congratulatory message is displayed to a user indicating the solution of the current anagram by the user in the elapsed time between the starting and the stopping of the timer. A method implements the system.

### FIELD OF THE DISCLOSURE

The present disclosure relates generally to puzzles, and, more particularly, to a system, a computing device, and a method implementing an online distributed anagram game and scoring thereof.

### BACKGROUND OF THE DISCLOSURE

Humans have been scientifically named “Homo sapiens,” meaning “knowledgeable man,” due to the capacity of people to learn and retain knowledge. However, one characterization of human culture is that people engage in and enjoy play and games. This has led to an alternative naming of humans as “Homo ludens,” meaning “playing man.” Games in various forms have a long history.

In particular, word games have utility in education and entertainment in the form of educational and teaching aids, as well as entertaining, competitive, and challenging games. The benefits of such games include, but are not limited to, language and vocabulary building, intellectual development, fun and excitement, improving decision making and strategic thinking skills, and enhancing creativity through creative word play. Such games also aid in social interaction and stimulate excitement about words and languages. In addition, word games can be used as an enticement for users to view advertisements, as well as to earn value such as monetary or physical prizes.

Examples of such word games include anagrams, riddles, acrostics, palindromes, word grids, pangrams, and crossword puzzles. Some word games have been implemented using computer-based devices, such as the games named “LITERATI,” “WORDS WITH FRIENDS,” and “WORDLE,” as well as variations of such word games. Such computer-implemented word games can be distributed to multiple and diverse users over networks such as the Internet.

In particular, an anagram can include a word or phrase formed by rearranging the order of alphabetical symbols of another word or phrase. For example, “earth” is an anagram of “heart.” Alternatively, the anagram can include a set of alphabetical symbols of a word or phrase scrambled to be in any order, and not necessarily forming a valid word or phrase in a given language. For example, the string of symbols “aehrt” is an anagram of “earth” and “heart.”

### SUMMARY OF THE DISCLOSURE

According to an embodiment consistent with the present disclosure, a system, a computing device, and a method implement an online distributed anagram game and scoring thereof.

In an embodiment, a computing device is selectively connected, through a network, to a computer-based server having memory configured to store a solution to a current anagram as a final game state. The computing device comprises a first processor, a clock, a first memory, an input device, and a display. The first processor is configured to execute a first code stored therein.

The first memory is configured to store a plurality of game states including an initial game state and the final game state, wherein the final game state comprises the scrambled current anagram received from the computer-based server. The input device is configured to receive a plurality of inputs from a user. The display is configured by the first code to display a first plurality of screen regions which are initially blank as the initial game state, and to display a plurality of alphabetical symbols in a second plurality of screen regions with the plurality of alphabetical symbols scrambled as a current anagram. The first processor is configured to receive the scrambled current anagram from the computer-based server.

The display is configured to display the scrambled current anagram. The first processor is configured to start a timer using the clock, and is configured to interactively process the plurality of inputs and to generate corresponding control signals. The display, responsive to the control signals, is configured to modify the first plurality of screen regions from the initial game state to a plurality of intermediate game states. The first processor, responsive to one of the plurality of intermediate game states matching the final game state, is configured to stop the timer. The display, responsive to the matching, is configured to provide a reward to the user in the form of a display of a congratulatory message indicating the solution of the current anagram in the elapsed time between the starting and the stopping of the timer.

The first memory can be configured to store a predetermined plurality of rules. The first processor can be configured to generate a plurality of intermediate scores and a final score corresponding to each of the intermediate game states, respectively, using the predetermined plurality of rules. The display, responsive to the matching, can be configured to display the final score. The first memory can be configured to store a predetermined plurality of rules. The first processor can be configured to generate a plurality of intermediate scores and a final score corresponding to each of the intermediate game states, respectively, using the predetermined plurality of rules. The first processor can be further configured to influence each of the intermediate scores and the final score in view of a value of the timer. The value of the timer used to influence each of the intermediate scores can be determined locally, on the computing device, for each game state starting with a presentation of the initial game state on the display and ending upon the inputs from the user correspond to achieving the final game state. The display, responsive to the matching, can be configured to display the final score.

The congratulatory message can be a visual message or an audio message reproduced at the computing device. The visual message can be an animation simulating raining confetti, fireworks, or friendly messages (“Good Job!”). Each of the first and second plurality of screen regions can be arranged in first and second rows of screen regions on the display, respectively.

In another embodiment, a computer-based server comprises a communication interface, a processor, and a memory. The communication interface is operatively connected through a network to a plurality of computing devices each associated with a corresponding one of a plurality of users. The processor is configured to execute a code stored therein to provide and store a current anagram to be current during a first predetermined time. In one embodiment, the current anagram is created by a game editor. In another embodiment, the current anagram is generated automatically by the processor executing the code. In a further embodiment, the current anagram can be retrieved from a table of predetermined anagrams of words and phrases. The memory is configured to store the current anagram, to store a solution to a current anagram, and to store a first leaderboard of scores of the plurality of users. The solution is an unscrambled current anagram. The processor, through the communication interface, is configured to transmit the current anagram, the solution, and the first predetermined time to each of the plurality of computing devices. The processor, through the communication interface, is configured to receive scores of the users who attained the solution of the current anagram during the first predetermined time. The processor is configured to populate the first leaderboard with the received scores. The processor is configured to transmit the populated first leaderboard to at least a first computing device of the plurality of computing devices including a display configured to display the first leaderboard.

The memory can be configured to store a second leaderboard. The processor, through the communication interface, can be configured to receive completion times of the users who attained the solution of the current anagram during the first predetermined time. The processor can be configured to populate the second leaderboard with the received completion times. The processor can be configured to transmit the populated second leaderboard to at least a second computing device of the plurality of computing devices including a display configured to display the second leaderboard. In the case that the first predetermined time has expired, the processor can be configured to provide a new anagram as the current anagram to be current during a second predetermined time.

The server can further comprise a clock. The server, using the clock, can be configured to initiate a timer measuring time passing during the first predetermined time. The server, responsive to the first predetermined time expiring, can be configured to provide the new anagram to be the current anagram. The server, responsive to the first predetermined time expiring, can be configured to determine a second predetermined time. The server can be configured to reset the timer to measure time passing during the second predetermined time. Each of the first and second predetermined times can be a twenty-four hour period, wherein each of the plurality of computing devices can be associated with a respective first and second predetermined timer, and wherein the server can be further configured to be responsive to a signal from a respective computing device to initiate the timer and measure the passage of time during the first and second predetermined times.

In a further embodiment, a computer-based system comprises a computing device, a computer-based server, and a reward provisioning subsystem. The computing device includes a first communication interface, a first processor, a first memory, an input device, and a display.

The first processor is configured to execute a first code stored therein. The first memory is configured to store a plurality of game states including an initial game state and a final game state.

The input device is configured to receive a plurality of inputs from a user. The display is configured by the first code to display a first plurality of screen regions which are initially blank as the initial game state, and to display a plurality of alphabetical symbols in a second plurality of screen regions with the plurality of alphabetical symbols scrambled as a current anagram.

The computer-based server includes a second communication interface, a second processor, and a second memory. The second communication interface is operatively connected to the first communication interface through a network. The second processor is configured to execute a second code stored therein. The second memory is configured to store a solution to the current anagram as the final game state. The second processor is configured to transmit the final game state to the first processor through the first and second communication interfaces. The first processor is configured to interactively process the plurality of inputs and to generate corresponding control signals. The display, responsive to the control signals, is configured to modify the first plurality of screen regions from the initial game state to a plurality of intermediate game states. The first processor, responsive to one of the plurality of intermediate game states matching the final game state, is configured to generate a reward signal. The reward provisioning subsystem, responsive to the reward signal, is configured to provide a reward to the user.

The matching intermediate game state can correspond to a predetermined plurality of words as the current anagram in an unscrambled configuration. Each of the first and second plurality of screen regions can be arranged in first and second rows of screen regions on the display, respectively. The input device and the display can be integrated in a touchscreen. The reward can be selected from the group consisting of: an audio message to the user, a visual message to the user, a monetary value stored in the second memory and associated with the user, and a physical token delivered to the user. The visual message can be a final score. The first memory can be configured to store a predetermined plurality of rules. The first processor can be configured to generate a plurality of intermediate scores and the final score corresponding to each of the intermediate game states, respectively, using the predetermined plurality of rules.

The server can further include a clock configured to measure a passage of time. The server, responsive to a predetermined time passing, can be configured to provide a new anagram to be the current anagram. The first memory can be configured to store a streak value. The first processor can be configured to count a current anagram solved by the user for each predetermined time passing, and configured to store the number of counted solved anagrams as the streak value. The display can be configured to display the streak value to the user.

In still another embodiment, a computer-based method comprises providing a computing device including a first communication interface, a first processor configured to execute a first code stored therein, a first memory, an input device, and a display. The computer-based method further comprises providing a computer-based server including a second communication interface, a second processor configured to execute a second code stored therein, and a second memory. The computer-based memory further comprises storing a plurality of game states including an initial game state in the first memory, displaying a first plurality of screen regions which are initially blank as the initial game state, storing a solution to a current anagram in the second memory as a final game state, operatively connecting the second communication interface to the first communication interface through a network, transmitting the final game state to the first processor through the first and second communication interfaces, storing the final game state in the first memory, displaying a plurality of alphabetical symbols in a second plurality of screen regions of the display with the plurality of alphabetical symbols scrambled as the current anagram, receiving a plurality of inputs at an input device from a user, and interactively processing the plurality of inputs by the first processor, generating control signals corresponding to the plurality of inputs.

The computer-based method further comprises, responsive to the control signals, modifying the first plurality of screen regions on the display from the initial game state to a plurality of intermediate game states. The computer-based method then determines, using the first processor, the case that one of the plurality of intermediate game states matching the final game state. The computer-based method further comprises, responsive to a matching of the one of the plurality of intermediate game states to the final game state, generating a reward signal by the first processor, and receiving the reward signal at a reward provisioning subsystem. The computer-based method, responsive to the reward signal, further comprises providing a reward to the user using a reward provisioning subsystem.

The computer-based method further comprises storing a predetermined plurality of rules in the first memory, and generating a plurality of intermediate scores and a final score corresponding to each of the intermediate game states, respectively, using the predetermined plurality of rules. The visual message can be the final score.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic of a system, according to an embodiment.

FIG. 2 is a schematic of a server of FIG. 1.

FIG. 3 is a schematic of a computing device of FIG. 1.

FIG. 4 is a schematic of a reward provisioning subsystem of FIG. 1.

FIGS. 5-12 are screenshots of operation of an anagram game on the computing device of FIG. 3 according to the illustrated embodiment.

FIGS. 13A-13B are flowcharts of a method of operation of the system of FIG. 1.

FIG. 14 is a flowchart of a scoring procedure.

FIG. 15 is a flowchart of a new anagram generating procedure.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 10, a computing device 40, and a method 1000 implementing an online distributed anagram game.

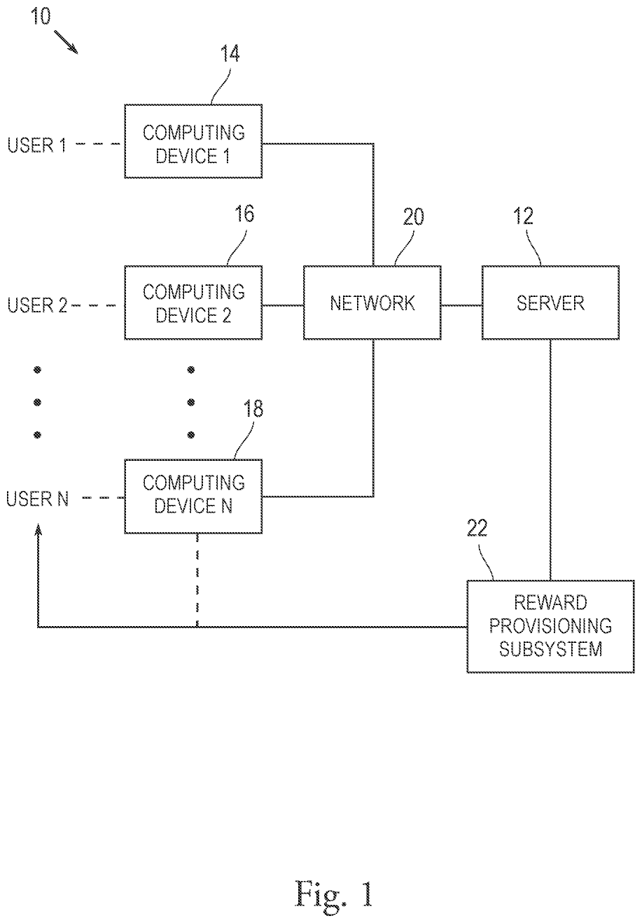

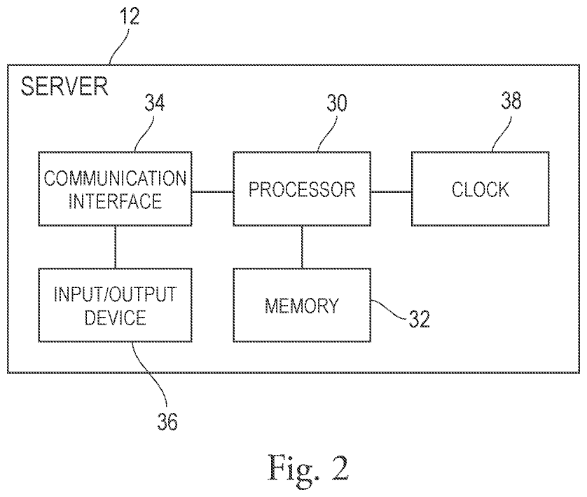

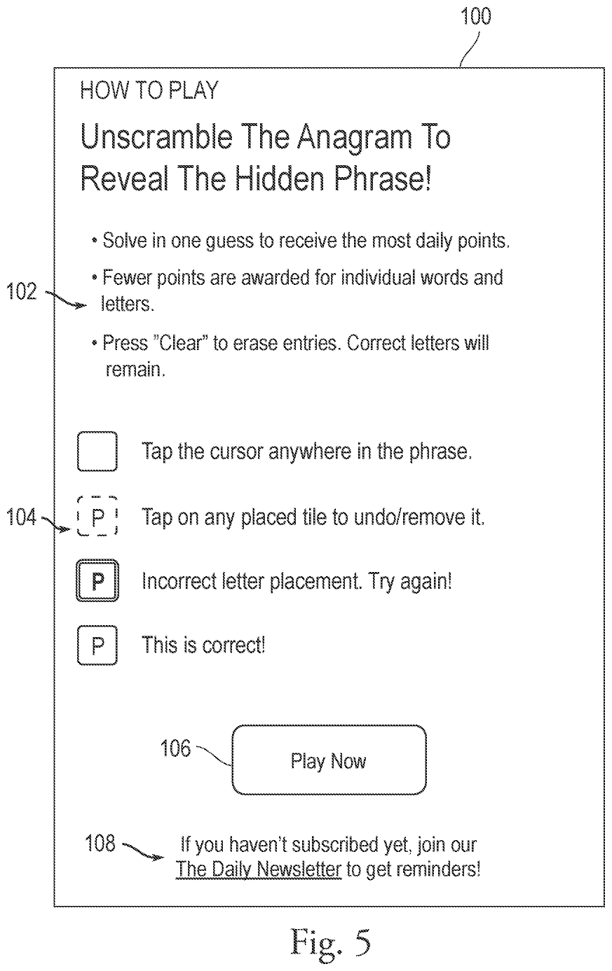

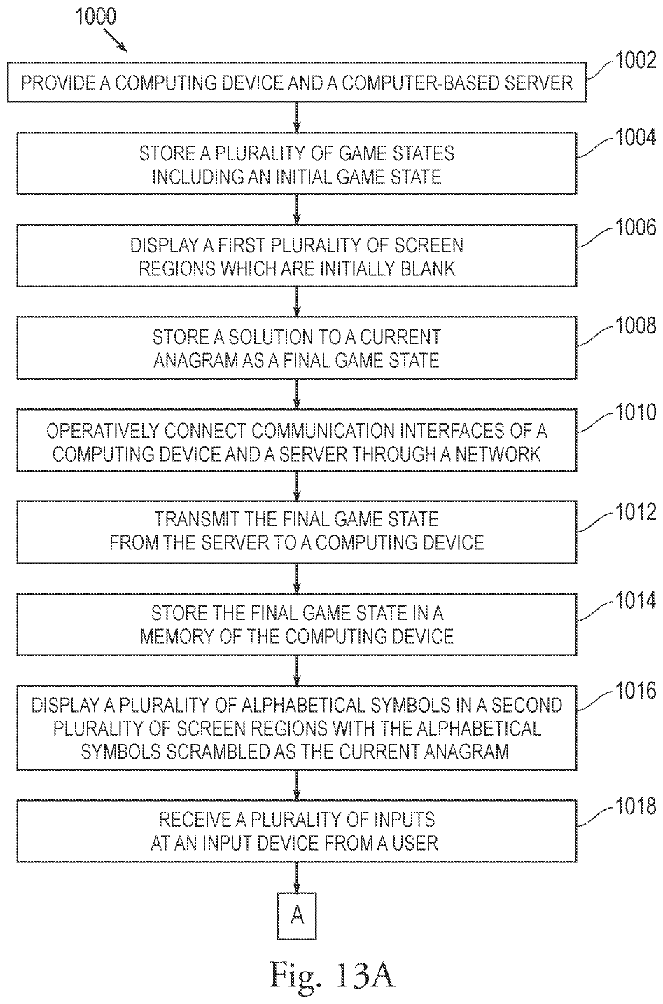

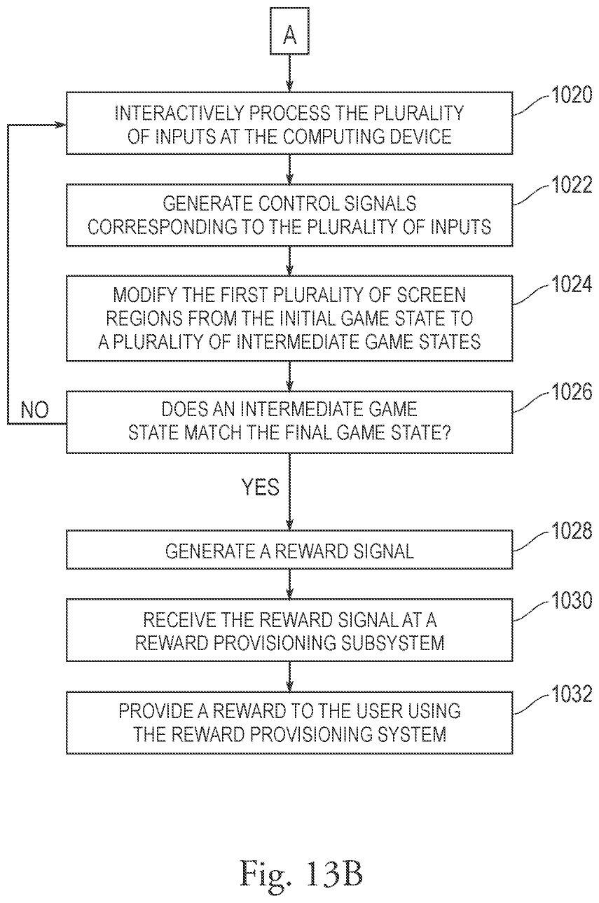

Referring to FIGS. 1-4, the system 10 includes various components configured to implement display screens on the computing device 40, as shown in FIGS. 5-12. The system 10 operates according to the method 1000 and procedures shown in FIGS. 13A-15. As shown in FIG. 1, the system 10 includes a server 12 operatively connected to at least one computing device 14, 16, 18 through a network 20. The server 12 is described in greater detail below with regard to FIG. 2. The network 20 can be the Internet. Alternatively, the network 20 can be a wide area network (WAN). In another embodiment, the network 20 can be a local area network (LAN).

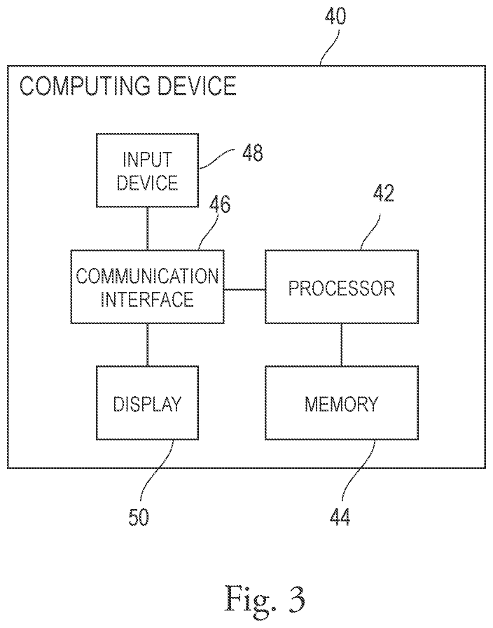

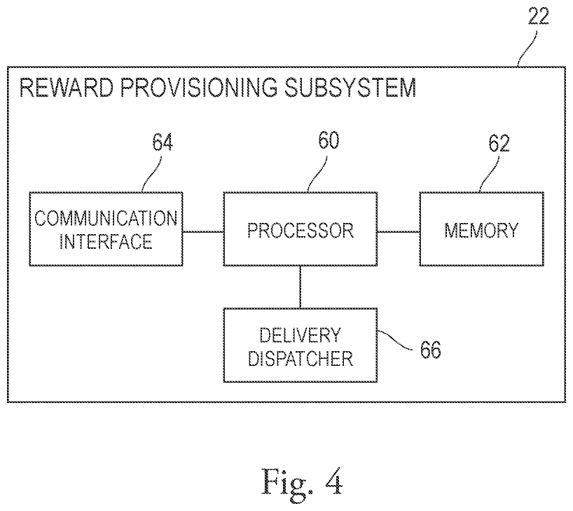

Furthermore, the network 20 can be any known communication device interconnecting the server 12 to the at least one computing device 14, 16, 18. Each computing device 14, 16, 18 is associated with a respective user, such as User 1, User 2, through User N. The system 12, though the network 20, provides a distributed online anagram game to the plurality of users using associated computing devices 14, 16, 18. The computing devices 14, 16, 18 is described in greater detail below with regard to FIG. 3. The server 12 is also operatively connected to a reward provisioning subsystem 22, as described in greater detail below with regard to FIG. 4.

As shown in FIG. 2, the server 12 includes a processor 30 operatively connected to a memory 32, a communication interface 34, an input/output device 36, and a clock 38. The processor 30 executes code stored therein. In one embodiment, the current anagram is created by a game editor and processes by the processor 30. For example, the processor 30 can provide the current anagram by distributing the current anagram to each of the computing devices 14, 16, 18. In another embodiment, the current anagram is generated automatically by the processor 30 executing the code. In a further embodiment, the current anagram can be retrieved from a table of predetermined anagrams of words and phrases. The table can be stored in the memory 32. Alternatively, the table can be retrieved by the processor 30 from a third-party through the network 20. The memory 32 is configured to store the current anagram, to store a solution to a current anagram, and to store a first leaderboard of scores of the plurality of users. Through the communication interface 34, the server 12 is operatively connected to the computing devices 14, 16, 18 through the network 20. In addition, through the communication interface 34, the server 12 is operatively connected to the reward provisioning subsystem 22. The communication interface 34 can be any known hardware configured to operate a known communication protocol. The input/output device 36 can allow a system administrator to set parameters of operation of the anagram game. For example, the system administrator can set the predetermined time period used by the clock 38 and the processor 30 to provide a new anagram to be a current anagram for the current time period. The default time period can be twenty-four hours, which can be modified by the system administrator. The server 12 can further include an encryption module configured to encrypt the current anagram prior to transmission of the current anagram to each computing device 14, 16, 18 through the network. In turn, each computing device 14, 16, 18 can include a decryption module configured to decrypt the encrypted current anagram.

In addition, to retain user data in the memory 32, such as game success streaks, as described in greater detail below, the server 12 can include a registration module. Using the registration module, the server 12 can allow users to register an account to play the anagram game by providing a user name and password. Accordingly, the user data such as game success streaks, can be available to the user through the account of the user regardless of the computing devices 14, 16, 18 used by a given user.

As shown in FIG. 3, each of the computing devices 14, 16, 18 can be embodied as a computing device 40. The computing device 40 includes a processor 42 executing code stored therein, a memory 44, and a communication interface 46. The processor 42 can include a clock. Alternatively, the computing device 40 can include a clock separate from but operatively connected to the processor 42. The communication interface 46 can be any known hardware configured to operate a known communication protocol. Through the communication interface 46, the processor 42 is operatively connected to an input device 48 and a display 50. The input device 48 and the display 50 are configured to interact with a respective user associated with the computing device 40. In one embodiment, the input device 48 and the display 50 can be integrated in an interactive touchscreen of the computing device 50. The touchscreen can be any known type of touch sensitive user interface. For example, the game screens shown in FIGS. 5-11 can implement graphical user interfaces (GUIs) with actuatable and selectable screen regions, such as icons. By implementing a touchscreen as the input device 48 and the display 50, the computing device 50 can receive and respond to user inputs; for example, when the user taps an icon selected by the user to control and play the anagram game. The computing device 40 can be a smartphone. Alternatively, the computing device 40 can be a tablet. Furthermore, the computing device 40 can be a personal computer. The processor 42 can be a microprocessor. The code executed by the processor 42 can be an ANDROID-based application, app, or applet. Alternatively, the code executed by the processor 42 can be an APPLE IOS-based application, app, or applet. In still other implementations, the input device 48 can be separate from the display, such as a keyboard having alphanumerical keys and control keys. The control keys of the keyboard can include a TAB key. Alternatively, the input device 48 can be a mouse used in conjunction with a cursor displayed on the display 50. The mouse can be any known type of mouse, such as having clickable buttons. Alternatively, the mouse can have a roller wheel or a roller ball.

In addition, the communication interface 46 of the computing device 40 is operatively connected to the network 20. The communication interface 46 can be operatively connected to the reward provisioning subsystem 22. Alternatively, the reward provisioning subsystem 22 interacts directly with a user associated with a respective computing device 14, 16, 18, as shown in FIG. 1.

As shown in FIG. 4, the reward provisioning subsystem 22 includes a processor 60 operatively connected to a memory 62, a communication interface 64, and a delivery dispatcher 66. The processor 60 executes code stored therein. The communication interface 64 can be any known hardware configured to operate a known communication protocol. In case the reward is an audio message to a user, such as a congratulatory sound upon completion of the anagram game by the user, the reward provisioning subsystem 22 can send an audio signal to a computing device 14, 16, 18 associated with the user. The respective computing device 14, 16, 18 can include a sound speaker, responsive to the audio signal, to output the congratulatory sound. In another alternative embodiment, the congratulatory sound can be an actual or a synthesized voice.

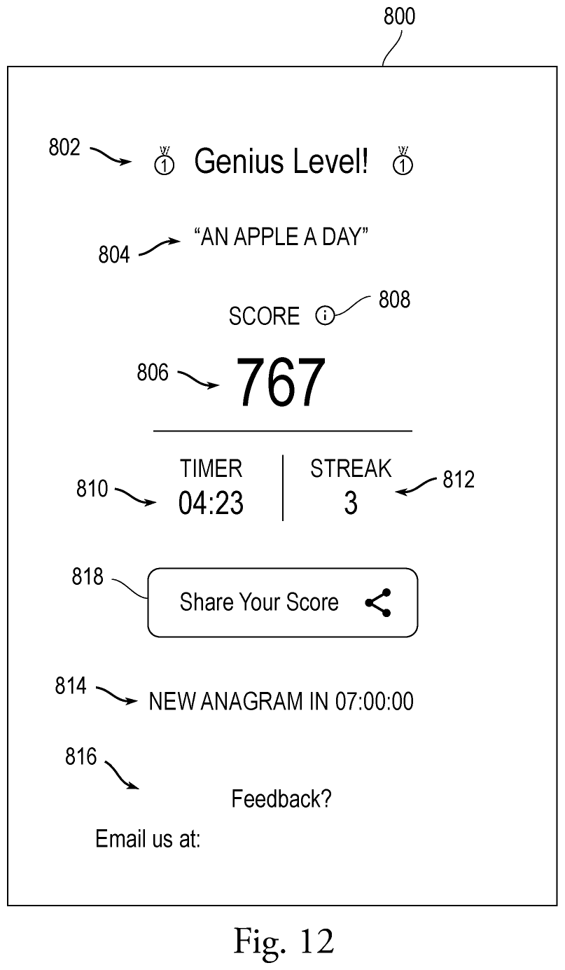

Alternatively, in case the reward is a visual message to a user, such as a congratulatory visual effect upon completion of the anagram game by the user, the reward provisioning subsystem 22 can send a visual effect signal to a computing device 14, 16, 18 associated with the user. The respective computing device 14, 16, 18 includes the display 50, responsive to the visual effect signal, to display the congratulatory visual effect, such as an animation simulating raining confetti. Alternatively, the visual message can be an animation simulating fireworks or friendly messages, such as, for example, “Good Job!”. In another alternative embodiment, the congratulatory visual effect can be a visual text message, such as a congratulatory screen; for example, as shown in FIG. 12. In a further embodiment, the congratulatory visual effect can be a video, an animation, or any known type of visual effect.

In another alternative embodiment, the reward can be a display of a username on a leaderboard of players of the anagram game, with the username associated with the user. Using the leaderboard, the system 10 can provide comparative ranking of the user relative to the other players of the anagram game. The ranking of users on the leaderboard can be based on the scores of the users. Alternatively, the ranking of the users on the leaderboard can be based on the elapsed time in which each user solves the anagram. In another embodiment, the ranking of the users on the leaderboard can be based on the length of game success streaks of each user.

In a further alternative embodiment, the reward can be a hyperlink in a visual message, such as an E-mail to the user. Once actuated, the hyperlink can direct the user to access a free online issue of a magazine or other publications or podcasts, streaming services and so on. Such a hyperlink and free online issue can incentivize the user to subscribe to the magazine or other publications. In this regard, the host of the game can coordinate users who have registered to play the game with available rewards and provide such rewards to the user.

In another embodiment, in case the reward is a monetary value, the reward provisioning subsystem 22 can transmit a message through the communication interface 64 to a financial institution; for example, to credit a financial account of the user with a nominal monetary prize upon completion of the anagram game by the user. Alternatively, the monetary credit can be stored in the memory 32 of the server 12. In a further embodiment, the reward provisioning subsystem 22 can reward the user with one cent upon completion of the anagram game. In another embodiment, the reward provisioning subsystem 22 can reward the user with a physical token, such as a bank check physically sent to the user through the delivery dispatcher 66. Such financial rewards provide an incentive for the user to repeatedly return to the anagram game.

In still another embodiment, in case the reward is a physical token, the reward provisioning subsystem 22 can send the physical token to the user through the delivery dispatcher 66. The physical token can be a physical certificate indicating completion of the anagram game. Alternatively, the physical token can be a physical prize, such as a trophy. In another alternative embodiment, the physical token can be a free physical copy of an issue of a magazine or other publications to be delivered to the user. The receipt of the free physical copy of the issue by the user can incentivize the user to subscribe to the magazine or other publications. In a further embodiment, the delivery dispatcher 66 can be a fulfillment service provider, such as “AMAZON,” “FEDERAL EXPRESS,” or “UNITED PARCEL SERVICE,” configured to send a physical token to the user. Alternatively, the fulfillment service provider can include a magazine or publication delivery system configured to send a free physical copy of the magazine or other publications as the physical token or reward to the user.

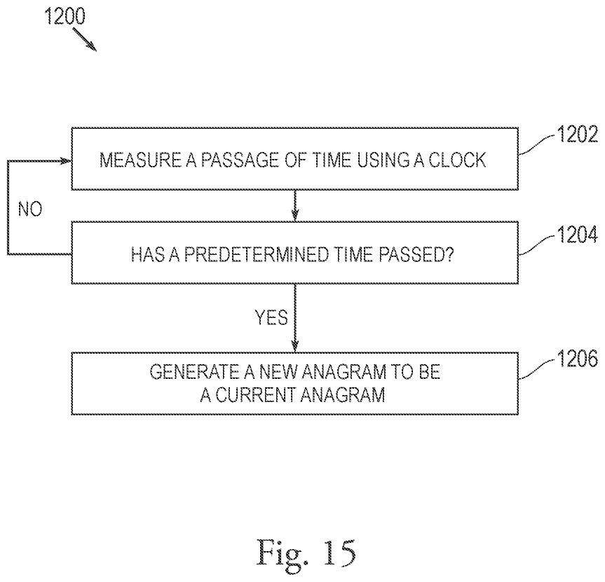

In operation, as shown in FIG. 15 and described in greater detail below, after a predetermined period of time as measured by the clock 38 of the server 12, the system 10 provides each computing device 14, 16, 18 with a new anagram and its corresponding unscrambled solution phrase. The predetermined period of time can be twenty-four hours, so a user has one current anagram and its solution phrase on a daily basis. The predetermined period of time can be determined from the geographic location of the server 12. Alternatively, the predetermined period of time can be determined to start from any default time, which can be modified by a system administrator. For example, the predetermined period of time can be measured from Eastern Standard Time; that is, Coordinated Universal Time (UTC)-5:00. In an alternative embodiment, after a user has solved the current anagram, the system 10 can permit the user to play again with a new anagram and corresponding solution phrase based on the elapsed time since the user has solved the current anagram. In such an embodiment, the system has a plurality of timers corresponding to the plurality of computing devices associated with respective plural users, so that each timer sets a window and tracks elapsed time for each user.

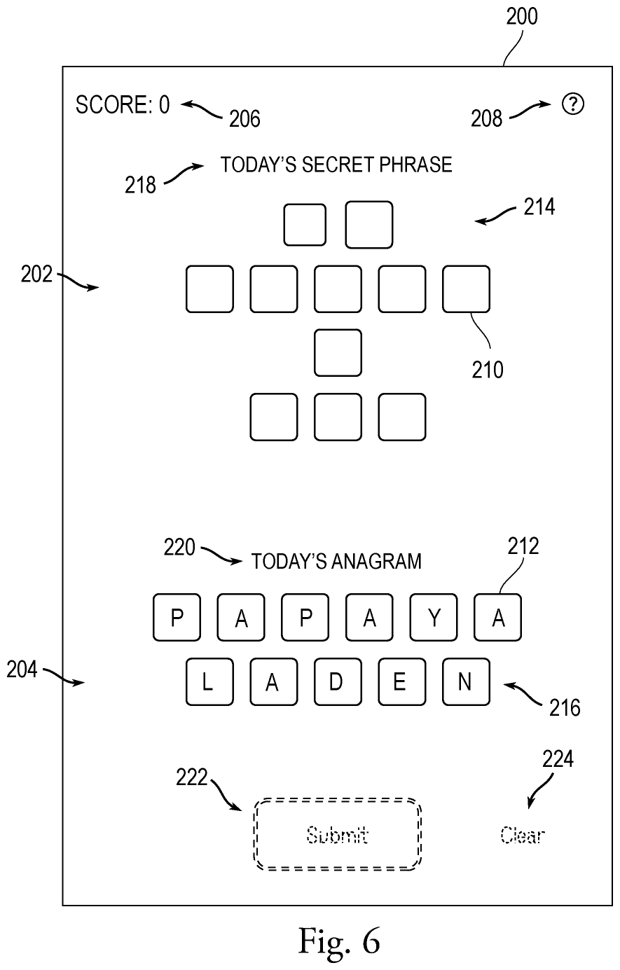

As shown in FIG. 5, a user is presented an introduction screen 100 on the display 50 of the computing device 14, 16, 18 associated with the user. The game rules 102 explain to the user the basic rules and goals of the anagram game. The interface description 104 explains to the user the basic functionality of the actuatable regions of the game screen, as shown in FIGS. 6-11. The introduction screen 100 also includes an actuatable icon 106 configured to initiate a game session for play by the selecting user. The introduction screen 100 can also include a message 108 to the user. For example, the message 108 can prompt the user to subscribe to a game newsletter. Alternatively, using a link in the message 108, the user can subscribe to a push notification service to prompt the user to receive notifications such as reminders of the state of play of the anagram game by the user.

After the user initiates a game session by selecting the icon 106 in FIG. 5, the computing device 40 displays an initial game screen 200 shown in FIG. 6. The computing device 40 can also start and stop a timer using the clock therein. The initial game screen 200 has screen regions 202, 204, as well as score message 206, and an information icon 208 configured to access additional information about the anagram game. The screen regions 202, 204 have a plurality of actuatable screen elements or tiles 210, 212, arranged in at least one row 214, 216, respectively. The labels 218, 220 can identify each screen region 202, 204, respectively, such as the label “TODAY'S SECRET PHRASE” and “TODAY'S ANAGRAM,” respectively.

The initial game screen 200 further includes a Submit icon 222, and a Clear icon 224. However, until the user selects an alphabetical symbol in the screen region 204, the Submit icon 222 and the Clear icon 224 have a faded appearance, indicating that the Submit function and the Clear function, respectively, as describe in greater detail below, are not initially available to the user.

As shown in FIG. 6, the first screen region 202 displays the selections by the user of alphabetical symbols displayed in the second screen region 204. The first screen region 202 is a work area in which the user enters selected alphabetical symbols from the second screen region 204. Since the initial game screen 200 displays the beginning of the anagram game, the tiles 210 in the rows 214 are initially blank. The initial game screen 200 corresponds to an initial game state.

The second screen region 204 displays the anagram; that is, the scrambled word or phrase which, when unscrambled, fits in the tiles 210 and rows 214 of the first screen region 204. For example, as shown in FIGS. 6-11, the anagram is “PAPAYA LADEN.” Although the anagram in the example of FIGS. 6-11 are actual words, that is, “PAPAYA” and “LADEN,” anagrams can have the required alphabetical symbols in any order. For example, instead of the anagram “PAPAYA LADEN” arranged in two rows, the anagram can be the alphabetical symbols “AAAADELNPPY,” arranged in one row with the scrambled symbols in alphabetical order. Alternatively, the anagram can be “AAAAE” and “DLNPPY,” arranged in two rows. In the alternative embodiment, the scrambled symbols in the first row can be only the vowels of the solution word or phrase, and the scrambled symbols in the second row can be only the consonants of the solution word or phrase.

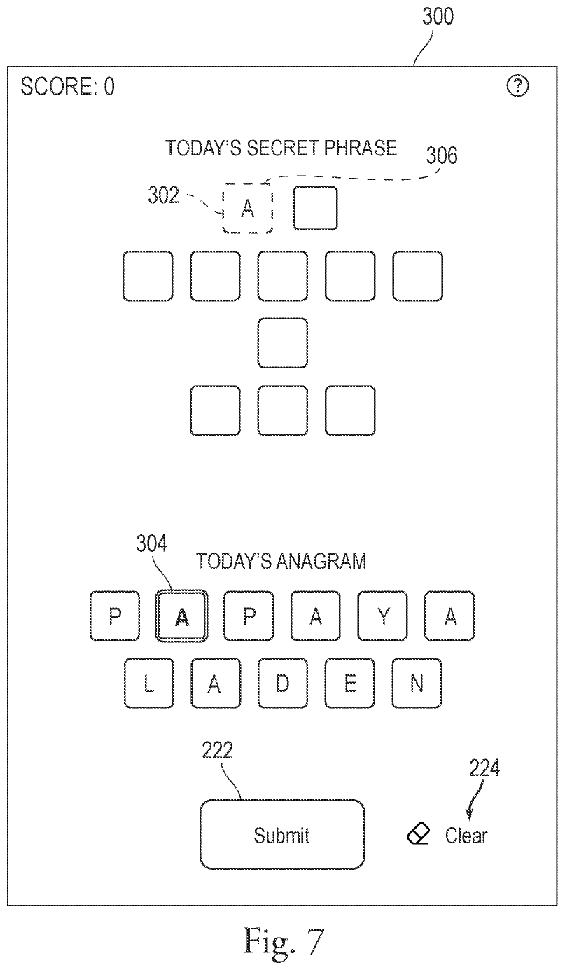

Referring to FIGS. 7-11, after the user has progressively selected and placed alphabetical symbols in the first region 202, the game screens 300, 400, 500, 600, 700, respectively, represent intermediate game states, which are stored in the memory 44 of the computing device 40 associated with the user playing the anagram game. As shown in FIG. 7, in the game screen 300, the user has tapped the tile 302 in the work area to set the cursor to the tile 302 to be an active tile. The active tile 302 can have an associated visual effect. For example, the active tile 302 can have a blinking animation. Alternatively, the active tile 302 can have a specific color for active tiles, such as red. The user then taps a tile 304 with an “A” in the anagram. The computing device 40, responsive to user inputs through the input device 48, places the “A” in the tile 304. In one embodiment, the user inputs correspond to user selection and entry of individual alphabetical keys on the keyboard of the input device 48. Alternatively, the user inputs correspond to user selection and entry of control keys, such as the TAB key for tabbing through and selecting tiles to place the entered alphabetical letter. In another alternative embodiment, the placement of the “A” can be performed by double-clicking the tile 304. In response to the double-clicking action, the computing device 40 places the “A” in the tile 302, and fades the title 304. Alternatively, the user can drag-and-drop the “A” in the tile 304 to the tile 302. In response to the drag-and-drop action, the computing device 40 places the “A” in the tile 302, and fades the title 304.

Upon placement of the “A” in the tile 302, the border 306 of the tile 302 can have a dashed-line appearance, indicating that the user can undo or remove the “A” from the tile 302 by tapping on the tile 302. In addition, since the user has selected and placed an alphabetical symbol from the anagram to the work area, the Submit icon 222 and the Clear icon 224 are no longer faded in appearance. Accordingly, the user can actuate the Submit icon 222 to submit the phrase in the work area as the proposed solution to the anagram. Alternatively, the user can actuate the Clear icon 224 to cause the computing device 40 to erase entries in the work area which are incorrect, while the computing device 40 retains the correct alphabetical symbols in the work area. In another alternative embodiment, actuation of the Clear icon 224 by the user can clear all entries from the work area, and so the user can start the anagram game fresh. This clearing of all entries applies when the user has not submitted any alphabetical entries that are correct. Actuation of the Clear icon 224 removes any un-submitted tiles, regardless of whether they are correct or not. In another embodiment, correct alphabetical symbols in the work area can have a specific color, such as green. However, incorrect guesses of alphabetical symbols in the work area can have a different color, such as turning red for a specific period of time. The specific period of time can be, for example, 1.5 seconds. After the specific period of time, the incorrect guesses are then cleared from the work area.

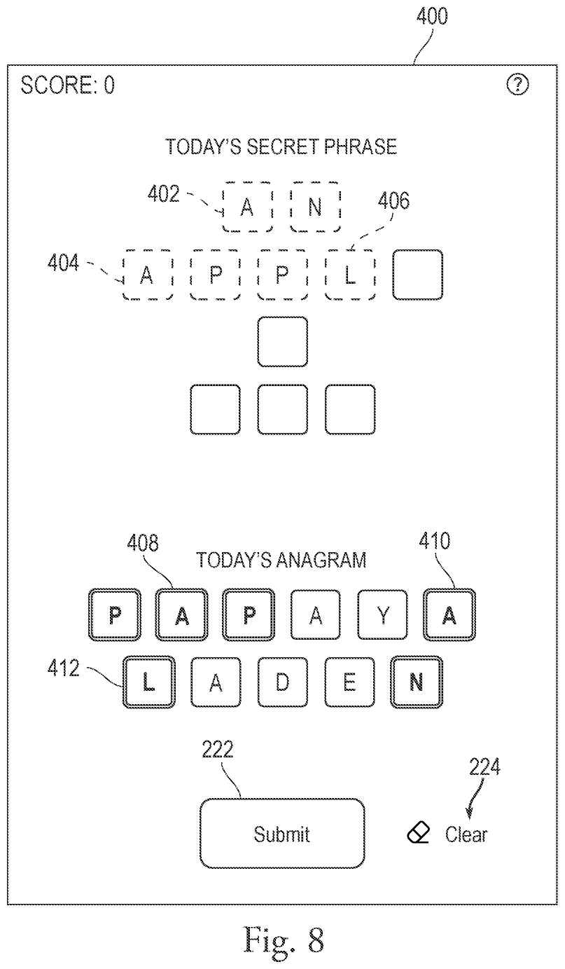

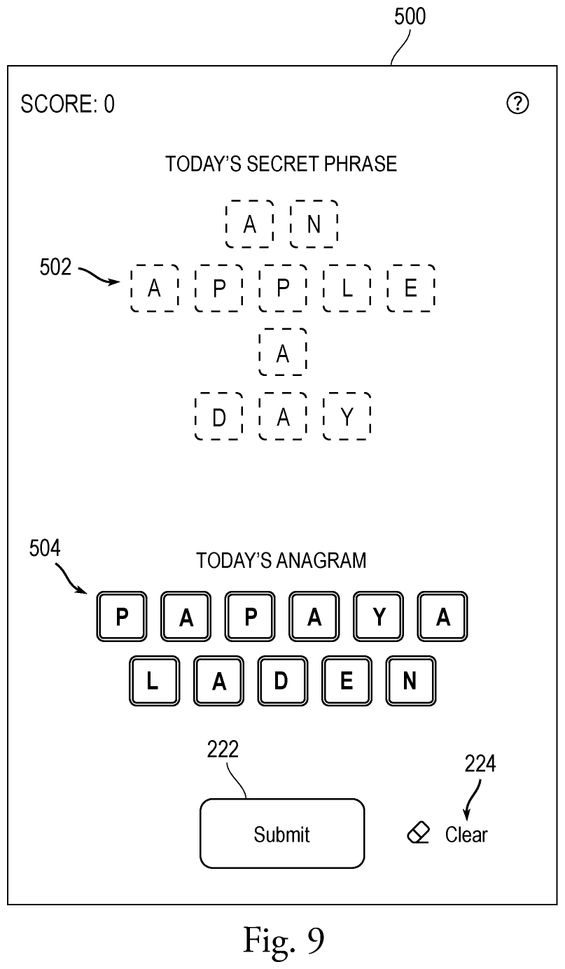

As shown in FIG. 8, in the screen 400, the user has placed more alphabetical symbols 402, 404, 406 in the work area, and corresponding tiles 408, 410, 412 in the anagram are faded. The screen 400 represents another intermediate game state. At any time, the user can press the Submit icon 222 to submit the proposed phrase as the completed unscrambled anagram. Actuation of the Submit icon 222 is specific to guessing individual letters. The benefit of guessing individual letters versus the whole anagram is from a scoring perspective. One cannot get the highest possible score if the user does not guess the full anagram without any errors. As shown in FIG. 9, in the screen 500, the user has placed all of the alphabetical symbols 502 from the anagram into the work area, and corresponding tiles 504 in the anagram are faded. The screen 500 represents another intermediate game state. At any time, the user can press the Submit icon 222 to submit the proposed phrase as the completed unscrambled anagram.

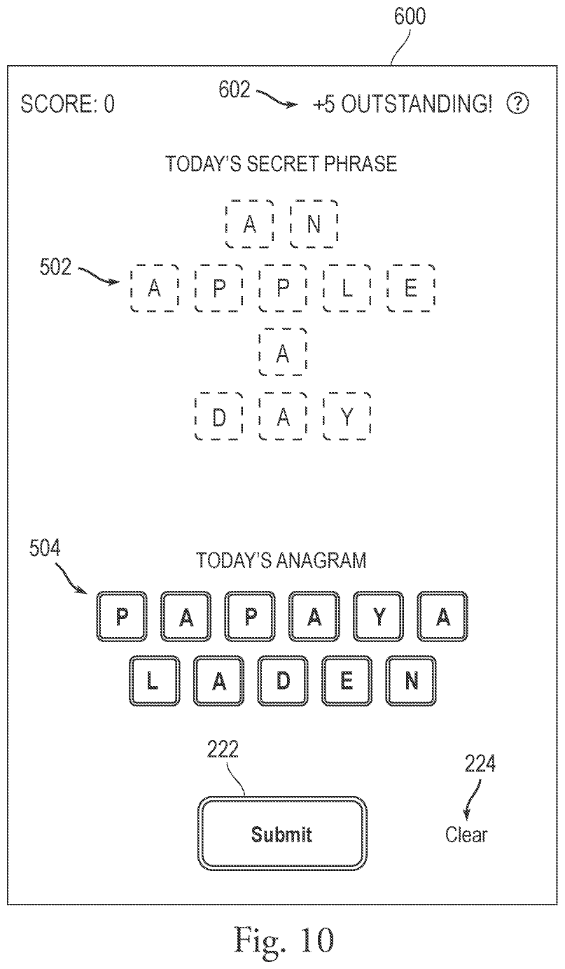

As shown in FIG. 10, the user has actuated the Submit icon 222 to submit the proposed phrase as the completed unscrambled anagram. In response, the computing device 40 causes the Submit icon 222 and the Clear icon 224 to be changed to a faded appearance in the screen 600. The screen 600 represents another intermediate game state. In FIG. 10, the computing device 40 has matched the proposed phrase 502 in the screen 600 to the solution to the anagram, and so a score of +5 is generated from the matching of the proposed phrase 502 to the solution. The score “+5” is shown in a score message 602 in the screen 600. The score message 602 can also include a commentary which can be positive feedback. For example, the word or phrase “OUTSTANDING!” can be displayed in the score message 602. Upon the matching of the proposed phrase 502 to the solution of the current anagram, the computing device 40 can then stop the timer to determine an elapsed time between the start and end of the solving of the current anagram by the user.

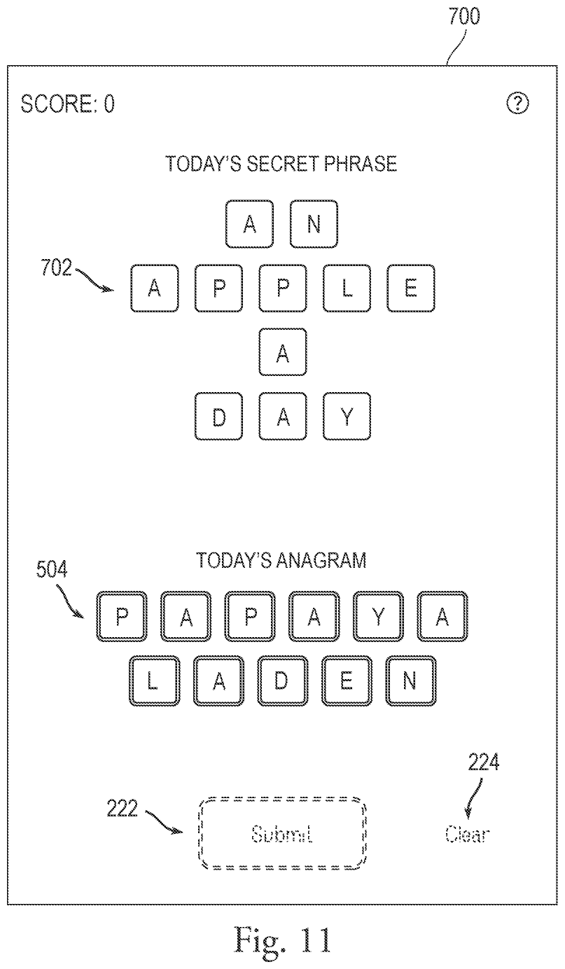

As shown in FIG. 11, since the computing device 40 has matched the proposed phrase 702 in the screen 700 to the solution to the anagram, the tiles in the proposed phrase 702 on the screen 700 have solid borders, representing that the placement of the alphabetical symbols is correct. Accordingly, the intermediate game state shown in FIG. 11 is the final game state. In response to the user achieving the final game state with the anagram completely unscrambled, as shown in FIG. 11, the computing device 40 associated with the user generates and displays to the user, on the display 50, a success screen 800 as shown in FIG. 12. Various messages can be displayed on the success screen 800, such as an indication 802 of the level of expertise of the user who has solved the current anagram. Another message 804 can display the anagram solution, and an overall score message 806 can be prominently displayed. An information icon 808 can be actuated to provide the user with further information. For example, the breakdown of the overall score can be explained to the user. The overall score 806 can factor in the completion time, which is the elapsed time measured by the timer of the computing device 40 which the user took to solve the current anagram. The completion time 810 can also be displayed on the screen 800.

In addition, a current streak of the user in solving anagrams across multiple consecutive predetermined time periods can be displayed in a streak message 812. The user can also be informed by a next anagram message 814 as to when a new anagram game can be played with a new anagram. For example, the new anagram can be provided by the server 12 on a daily basis. Accordingly, as shown in FIG. 12, a new anagram is to be available to the corresponding user in seven hours. The success screen 800 can also prompt the user to provide feedback in a feedback prompting message 816. The feedback prompting message 816 can include an Email address allowing a user to submit feedback. Other methods of providing feedback can include text messages to game administrators, posts to social media, or other known feedback techniques.

In addition, the success screen 800 can include an icon 818 for sharing the score of the user to social media, such as “FACEBOOK,” “INSTAGRAM,” “TWITTER,” or other social media platforms. The score of the user can be shared on an individual basis. Alternatively, the server 12 can store a user identifier and the score of the user in the memory 32. The server 12 can also generate and display a leaderboard configured to be view by the user or by multiple users. For example, the leaderboard can be displayed on the success screen 800.

As shown in FIGS. 13A-13B, a method 1000 of operation of the computer-based system 12 includes the steps of providing the computing device 40 and the computer-based server 12 in step 1002, storing a plurality of game states including an initial game state in step 1004, displaying a first plurality of screen regions which are initially blank in step 1006, storing a solution to a current anagram as a final game state in the memory 32 of the server 12 in step 1008, operatively connecting communication interfaces 34, 46 of the server 12 and the computing device 40 through the network 20 in step 1010, and transmitting the final game state from the server 12 to the computing device 40 in step 1012.

The method 1000 then includes the steps of storing the final game state in the memory 44 of the computing device 40 in step 1014, displaying a plurality of alphabetical symbols in a second plurality of screen regions with the alphabetical symbols scrambled as the current anagram in step 1016, and receiving a plurality of inputs at the input device 48 of the computing device 40 associated with the user in step 1018. The method 1000 then includes the steps of interactively processing the plurality of inputs at the computing device 40 in step 1020, generating control signals corresponding to the plurality of inputs in step 1022, and modifying the first plurality of screen regions from the initial game state to a plurality of intermediate game states in step 1024.

The method 1000 then checks in step 1026 whether an intermediate game state matches the final game state. If not, the method 1000 loops back to perform steps 1020-1026. Otherwise, if there is a match of an intermediate game state to the final game state in step 1026, the method 1000 proceeds to generate a reward signal in step 1028, receive the reward signal at the reward provisioning subsystem 22 in step 1030, and provide a reward to the user using the reward provisioning subsystem 22 in step 1032.

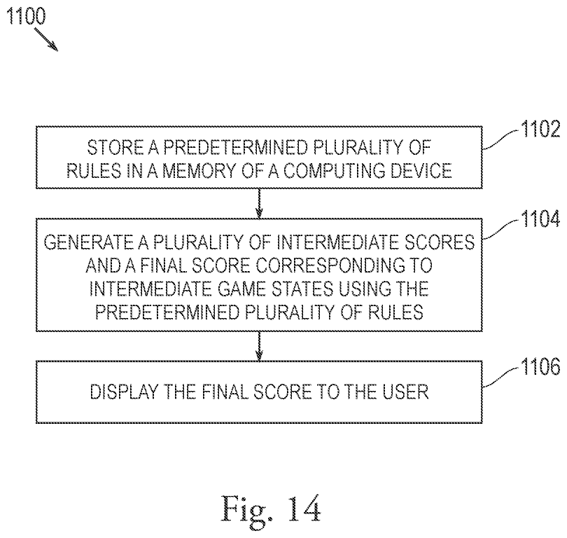

In addition, the system 10 performs a scoring procedure 1100 shown in FIG. 14, including the steps of storing a predetermined plurality of rules in the memory 44 of the computing device 40 in step 1102, generating a plurality of intermediate scores and a final score corresponding to intermediate game states using the predetermined plurality of rules in step 1104, and displaying the final score to the user in step 1106. For example, if a user guesses the entire secret phrase correctly on a first guess, the user receives the following amount of points based on the number of characters in the secret phrase: for 20 or more characters, the user receives 1000 points; for 13-19 characters, the user receives 800 points; and for up to 12 characters, the user receives 375 points.

If a user does not guess the entire secret phrase correctly on a first guess, then points are based off of how many characters within a word of secret phrase blocks which the user guessed correctly and if the user guessed the whole word correctly. For example, if the user guessed a whole word correctly, then the user receives the following points depending on the number of characters in that word: (CharactersCorrect*25)−25. However, if the word has one letter, the user receives just 10 points. If the user guessed a partial word correctly, then the user receives the following points depending on the number of characters in that word: (CharactersCorrect+8)*CharactersCorrect. If the user only gets one character correct, the user receives just 5 points. Points are accumulated every time that a user makes a submission by actuating the Submit icon 222. Accordingly, for example, if the user has 40 points, and on the latest submission, the user receives 10 points, the user has a total of 50 points.

In certain embodiments, the system 10, at each and every one of the computing devices 14, 16, etc. has its processor 42 further configured to influence each of the intermediate scores and the final score in view of a value of the timer which elapses starting with a presentation of the initial game state on the display and ending upon the inputs from the user corresponding to achieving the final game state. In this way, the speed at which the user inputs his or her selections can modify the score received to differ from the determinations just described. With the elapsed time monitored locally at each computing device, the system 10 is able to determine locally scores throughout game play that vary with the proficiency of each particular user. As a consequence, not only is the user's score influenced by their speed of play, but their ranking on a leaderboard, if provided, is likewise influenced.

Furthermore, the system 10 performs a new anagram generating procedure 1200 shown in FIG. 15, including the step of measuring a passage of time using a clock 38 at the server 12 in step 1202, and determining whether a predetermined time has passed in step 1204. The predetermined time can be twenty-four hours. If the predetermined time has not passed in step 1204, the procedure 1200 loops back to measure the passage of time in step 1202. Otherwise, if the predetermined time has passed in step 1204, the processor 30 of the server 12 generates a new anagram to be a current anagram in step 1206 by providing the new anagram as described above. The current anagram is used during the current predetermined time.

Local storage of game data by the computing device 40 instead of by the server 12 has various advantages. If a user leaves a game that was already started, refreshes a current tab, or opens a new tab, the state of the current game is preserved. In addition, the user is taken to the screen that the user was just on. Also, a game board state is the same as the last time that the user made a submission. Furthermore, if a user has guessed some blocks, but has not submitted guesses, those unsubmitted guesses are forgotten. In addition, points scored are preserved.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting.

For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A computing device selectively connected, through a network to a computer-based server having memory configured to store a solution to a current anagram as a final game state, comprising:
a first processor configured to execute a first code stored therein;
a clock;
a first memory configured to store a plurality of game states including an initial game state and the final game state, wherein the final game state comprises the scrambled current anagram received from the computer-based server;
an input device configured to receive a plurality of inputs from a user;
a display configured by the first code to display a first plurality of screen regions which are initially blank as the initial game state, and to display a plurality of alphabetical symbols in a second plurality of screen regions with the plurality of alphabetical symbols scrambled as a current anagram; and
wherein the first processor is configured to receive the scrambled current anagram from the computer-based server;
wherein the display is configured to display the scrambled current anagram;
wherein the first processor is configured to start a timer using the clock;
wherein the first processor is configured to interactively process the plurality of inputs and to generate corresponding control signals,
wherein the display, responsive to the control signals, is configured to modify the first plurality of screen regions from the initial game state to a plurality of intermediate game states,
wherein the first processor, responsive to one of the plurality of intermediate game states matching the final game state, is configured to stop the timer, and
wherein the display, responsive to the matching, is configured to provide a reward to the user in the form of a display of a congratulatory message indicating the solution of the current anagram in the elapsed time between the starting and the stopping of the timer.

2. The computing device of claim 1, wherein the first memory is configured to store a predetermined plurality of rules,
wherein the first processor is configured to generate a plurality of intermediate scores and a final score corresponding to each of the intermediate game states, respectively, using the predetermined plurality of rules, and
wherein the display, responsive to the matching, is configured to display the final score.

3. The computing device of claim 1, wherein the first memory is configured to store a predetermined plurality of rules,
wherein the first processor is configured to generate a plurality of intermediate scores and a final score corresponding to each of the intermediate game states, respectively, using the predetermined plurality of rules,
wherein the first processor is further configured to influence each of the intermediate scores and the final score in view of a value of the timer, wherein the value of the timer used to influence each of the intermediate scores is determined locally, on the computing device, for each game state starting with a presentation of the initial game state on the display and ending upon the inputs from the user correspond to achieving the final game state, and
wherein the display, responsive to the matching, is configured to display the final score.

4. The computing device of claim 1, wherein the congratulatory message is a visual message or an audio message reproduced at the computing device.

5. The computing device of claim 1, wherein each of the first and second plurality of screen regions is arranged in first and second rows of screen regions on the display, respectively.

6. A computer-based server, comprising:
a communication interface operatively connected through a network to a plurality of computing devices each associated with a corresponding one of a plurality of users;
a processor configured to execute a code stored therein to provide a current anagram to be current during a first predetermined time; and
a memory configured to store a solution to a current anagram and to store a first leaderboard of scores of the plurality of users,
wherein the solution is an unscrambled current anagram,
wherein the processor, through the communication interface, is configured to transmit the current anagram, the solution, and the first predetermined time to each of the plurality of computing devices,
wherein the processor, through the communication interface, is configured to receive scores of the users who attained the solution of the current anagram during the first predetermined time,
wherein the processor is configured to populate the first leaderboard with the received scores, and
wherein the processor is configured to transmit the populated first leaderboard to at least a first computing device of the plurality of computing devices including a display configured to display the first leaderboard.

7. The server of claim 6, wherein the memory is configured to store a second leaderboard,
wherein the processor, through the communication interface, is configured to receive completion times of the users who attained the solution of the current anagram during the first predetermined time,
wherein the processor is configured to populate the second leaderboard with the received completion times, and
wherein the processor is configured to transmit the populated second leaderboard to at least a second computing device of the plurality of computing devices including a display configured to display the second leaderboard.

8. The server of claim 6, wherein, in the case that the first predetermined time has expired, the processor is configured to provide a new anagram as the current anagram to be current during a second predetermined time.

9. The server of claim 8, further comprising:
a clock,
wherein the server, using the clock, is configured to initiate a timer measuring time passing during the first predetermined time,
wherein the server, responsive to the first predetermined time expiring, is configured to provide the new anagram to be the current anagram, and
wherein the server, responsive to the first predetermined time expiring, is configured to determine a second predetermined time, and
wherein the server is configured to reset the timer to measure time passing during the second predetermined time.

10. The server of claim 9, wherein each of the first and second predetermined times is a twenty-four hour period, wherein each of the plurality of computing devices is associated with a respective first and second predetermined timer, and wherein the server is further configured to be responsive to a signal from a respective computing device to initiate the timer and measure the passage of time during the first and second predetermined times.

11. A computer-based system, comprising:
a computing device including:
a first communication interface;
a first processor configured to execute a first code stored therein;
a first memory configured to store a plurality of game states including an initial game state and a final game state;
an input device configured to receive a plurality of inputs from a user; and
a display configured by the first code to display a first plurality of screen regions which are initially blank as the initial game state, and to display a plurality of alphabetical symbols in a second plurality of screen regions with the plurality of alphabetical symbols scrambled as a current anagram;
a computer-based server including:
a second communication interface operatively connected to the first communication interface through a network;
a second processor configured to execute a second code stored therein; and
a second memory configured to store a solution to the current anagram as the final game state; and
a reward provisioning subsystem,
wherein the second processor is configured to transmit the final game state to the first processor through the first and second communication interfaces,
wherein the first processor is configured to interactively process the plurality of inputs and to generate corresponding control signals,
wherein the display, responsive to the control signals, is configured to modify the first plurality of screen regions from the initial game state to a plurality of intermediate game states,
wherein the first processor, responsive to one of the plurality of intermediate game states matching the final game state, is configured to generate a reward signal, and
wherein the reward provisioning subsystem, responsive to the reward signal, is configured to provide a reward to the user.

12. The system of claim 11, wherein the matching intermediate game state corresponds to a predetermined plurality of words as the current anagram in an unscrambled configuration.

13. The system of claim 11, wherein each of the first and second plurality of screen regions is arranged in first and second rows of screen regions on the display, respectively.

14. The system of claim 11, wherein the input device and the display are integrated in a touchscreen.

15. The system of claim 11, wherein the reward is selected from the group consisting of: an audio message to the user, a visual message to the user, a monetary value stored in the second memory and associated with the user, and a physical token delivered to the user.

16. The system of claim 15, wherein the visual message is a final score,
wherein the first memory is configured to store a predetermined plurality of rules, and
wherein the first processor is configured to generate a plurality of intermediate scores and the final score corresponding to each of the intermediate game states, respectively, using the predetermined plurality of rules.

17. The system of claim 11, wherein the server further includes a clock configured to measure a passage of time, and
wherein the server, responsive to a predetermined time passing, is configured to provide a new anagram to be the current anagram.

18. The system of claim 17, wherein the first memory is configured to store a streak value,
wherein the first processor is configured to count a current anagram solved by the user for each predetermined time passing, and configured to store the number of counted solved anagrams as the streak value, and
wherein the display is configured to display the streak value to the user.

19. A computer-based method, comprising:
providing a computing device including a first communication interface, a first processor configured to execute a first code stored therein, a first memory, an input device, and a display;
providing a computer-based server including a second communication interface, a second processor configured to execute a second code stored therein, and a second memory;
storing a plurality of game states including an initial game state in the first memory;
displaying a first plurality of screen regions which are initially blank as the initial game state;
storing a solution to a current anagram in the second memory as a final game state;
operatively connecting the second communication interface to the first communication interface through a network;
transmitting the final game state to the first processor through the first and second communication interfaces;
storing the final game state in the first memory;
displaying a plurality of alphabetical symbols in a second plurality of screen regions of the display with the plurality of alphabetical symbols scrambled as the current anagram;
receiving a plurality of inputs at an input device from a user;
interactively processing the plurality of inputs by the first processor;
generating control signals corresponding to the plurality of inputs;
responsive to the control signals, modifying the first plurality of screen regions on the display from the initial game state to a plurality of intermediate game states;
determining, using the first processor, the case that one of the plurality of intermediate game states matching the final game state;
responsive to a matching of the one of the plurality of intermediate game states to the final game state, generating a reward signal by the first processor;
receiving the reward signal at a reward provisioning subsystem; and
responsive to the reward signal, providing a reward to the user using a reward provisioning subsystem.

20. The method of claim 19, further comprising:
storing a predetermined plurality of rules in the first memory; and
generating a plurality of intermediate scores and a final score corresponding to each of the intermediate game states, respectively, using the predetermined plurality of rules,
wherein the visual message is the final score.
